(19) United States
(12) Patent Application Publication
(10) Pub. No.: US 2013/0124800 A1
(43) Pub. Date: May 16, 2013

(54) APPARATUS AND METHOD FOR REDUCING PROCESSOR LATENCY

(71) Applicants: Michael Priel, Hertzelia (IL); Dan Kuzmin, Givat Shmuel (IL); Anton Rozen, Gedera (IL); Leonid Smolyansky, Zichron Yakov (IL)

(72) Inventors: Michael Priel, Hertzelia (IL); Dan Kuzmin, Givat Shmuel (IL); Anton Rozen, Gedera (IL); Leonid Smolyansky, Zichron Yakov (IL)

(73) Assignee: Freescale Semiconductor, Inc., Austin, TX (US)

(21) Appl. No.: 13/812,168

(22) PCT Filed: Jul. 27, 2010
(86) PCT No.: PCT/IB10/53410

§ 371 Date: Jan. 25, 2013

(51) Int. Cl. G06F 12/08

(52) U.S. Cl. CPC G06F 12/0802; G06F 12/0811
USPC 711/122; 711/118

(57) ABSTRACT

There is provided a data processing system comprising a central processing unit, a processor cache memory operably coupled to the central processing unit and an external connection operably coupled to the central processing unit and processor cache memory in which a portion of the data processing system is arranged to load data directly from the external connection into the processor cache memory and modify a source address of said directly loaded data. There is also provided a method of improving latency in a data processing system having a central processing unit operably coupled to a processor cache memory and an external connection operably coupled to the central processing unit and processor cache memory, comprising loading data directly from the external connection into the processor cache memory and modifying a source address for said data to become indicative of a location other than from the external connection.

### FIELD OF THE INVENTION

This invention relates to data processing systems in general, and in particular to an improved apparatus and method for reducing processor latency.

### BACKGROUND OF THE INVENTION

Data processing systems, such as PCs, mobile tablets, smart phones, and the like, often comprise multiple levels of memory storage, for storing and executing program code, and for storing content data for use with the executed program code. For example, the central processing unit (CPU) may comprise on-chip memory, such as cache memory, and be connectable to external system memory, external to the CPU, but part of the system.

Typically, computing applications are managed from a main external system memory (e.g. Double Data Rate (DDR) external memory), with program code and content data for executing applications being loaded into the main external system memory prior to use/execution. In the case of content data, this is often loaded from an external source, such as a network or main storage device, into the main external system memory through some external interface connection, for example the Universal Serial Bus (USB). The respective program code and content data is then loaded from the main external system memory into the cache memory, ready for actual use by a central processing unit. Copying data from such external interfaces, especially slower serial interfaces, to the main external system memory takes time and builds latency into the overall system, delaying the central processing unit from making use of the program code and content data.

### SUMMARY OF THE INVENTION

The present invention provides an apparatus, and method of improving latency in a processor as described in the accompanying claims.

Specific embodiments of the invention are set forth in the dependent claims.

These and other aspects of the invention will be apparent from and elucidated with reference to the embodiments described hereinafter.

### BRIEF DESCRIPTION OF THE DRAWINGS

Further details, aspects and embodiments of the invention will be described, by way of example only, with reference to the drawings. In the drawings, like reference numbers are used to identify like or functionally similar elements. Elements in the figures are illustrated for simplicity and clarity and have not necessarily been drawn to scale.

FIG. 1 schematically shows a first example of an embodiment of a data processing system to which the present invention may apply;

FIG. 2 schematically shows a second example of an embodiment of a data processing system to which the present invention may apply;

FIG. 3 schematically shows how content data is loaded from an external connection to the processor, via main external memory, according to the prior art;

FIG. 4 schematically shows how content data is loaded from an external connection to the processor according to an embodiment of the present invention;

FIG. 5 schematically shows in more detail a first example of how the embodiment of FIG. 4 may be implemented;

FIG. 6 schematically shows in more detail a second example of how the embodiment of FIG. 4 may be implemented;

FIG. 7 shows a high level schematic flow diagram of the method according to an embodiment of the present invention.

### DETAILED DESCRIPTION OF THE PREFERRED EMBODIMENTS

Because the illustrated embodiments of the present invention may for the most part, be implemented using electronic components and circuits known to those skilled in the art, details will not be explained in any greater extent than that considered necessary as illustrated, for the understanding and appreciation of the underlying concepts of the present invention and in order not to obfuscate or distract from the teachings of the present invention.

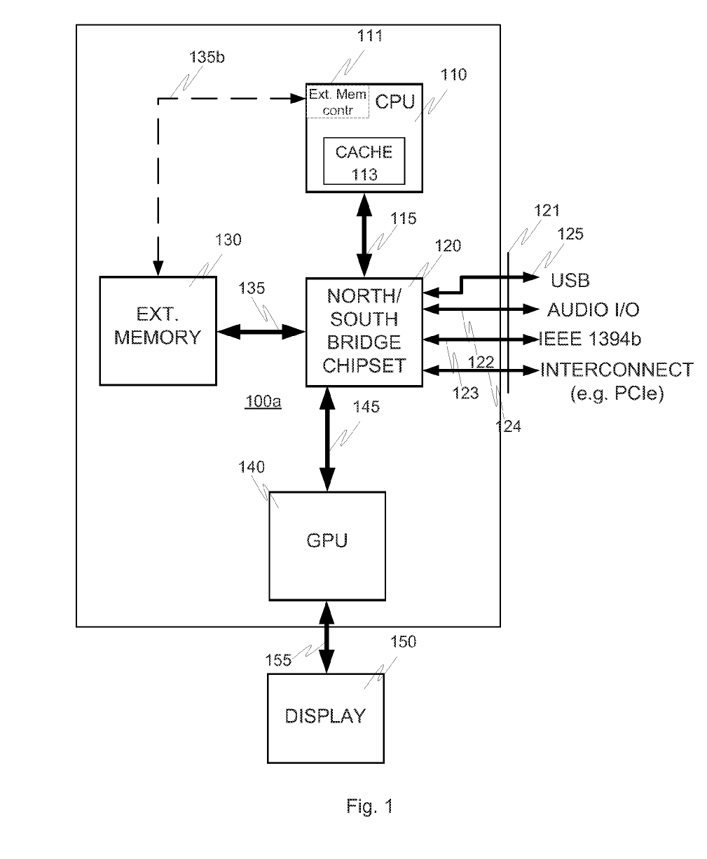

FIG. 1 schematically shows a first example of an embodiment of a data processing system 100a to which the present invention may apply.

It is a simplified schematic diagram of a typical desktop computer having a central processing unit (CPU) 110 including a level 2 cache memory 113, connected to a North/South bridge chipset 120 via interface 115. The North/South bridge chipset 120 acts as a central hub, to connect the different electronic components of the overall data processing system 100a together, for example, the main external system memory 130, discrete graphics processing unit (GPU) 140, external connection(s) 121 (e.g. peripheral device connections/interconnects (122-125)) and the like, and in particular to connect them all to the CPU 110.

In the example shown in FIG. 1, main external system memory 130 (e.g. DDR random access memory) may connect to the North/South bridge chipset 120 through external memory interface 135, or, alternatively, the CPU 110 may further include an integrated high speed external memory controller 111 for providing the high speed external memory interface 135b to the main external system memory 130. In such a situation, the main external system memory 130 does not use the standard external memory interface 135 to the North/South bridge chipset 120. The integration of the external memory controller into the CPU 110 itself is seen as one way to increase overall system data throughput, as well as reducing component count and manufacturing costs.

The discrete graphics processing unit (GPU) 140 may connect to the North/South bridge chipset 120 through dedicated graphics interface 145 (e.g. Advanced Graphics Port-AGP), and to the display 150, via display interconnect 155 (e.g. Digital Video Interface (DVI), High Definition Multimedia Interface (HDMI), D-sub (analog), and the like). In other embodiments, the discrete GPU 140 may connect to the North/South bridge chipset 120 through some non-dedicated interface, such as Peripheral Connection Interface (PCI) or PCI Express (PCIe—a newer, faster serialised interface standard).

Other peripheral devices may be connected through other dedicated external connection interfaces 121, such as Audio Input/Output 122 interface, IEEE 1394a/b interface 123, Ethernet interface (not shown), main interconnect 124 (e.g. PCIe, and the like), USB interface 125, or the like. Different embodiments of the present invention may have different sets of external connection interfaces present, i.e. the invention is not limited to any particular selection of external connection interfaces (or indeed internal connection interfaces).

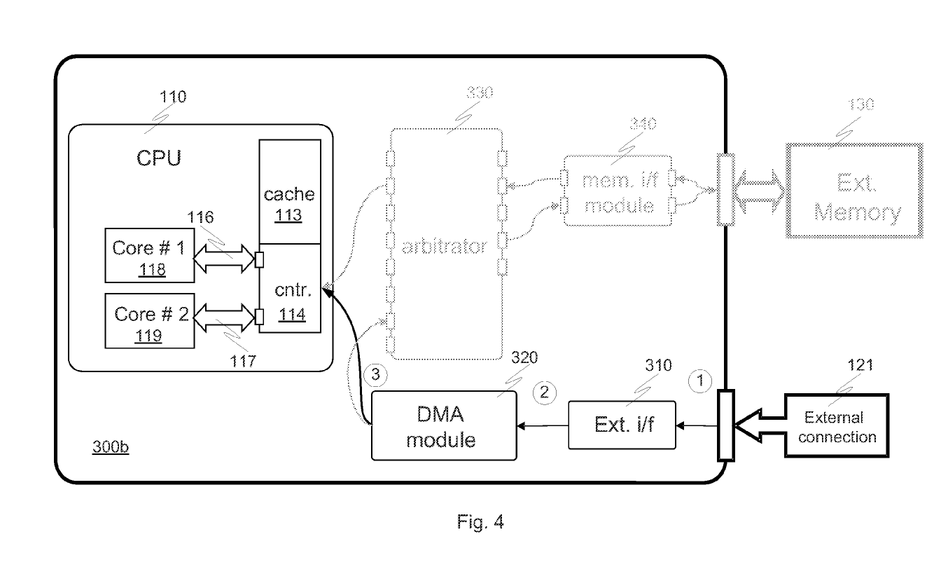

The integration of interfaces previously found within the North/South bridge chipsets 120 (or other discreet portions of the overall system) into the central processing unit 130 itself has been an increasing trend (producing so called “system-on-chip” designs). This is because integrating more traditionally discrete components into the main CPU 110 reduces manufacturing costs, fault rates, power usage, size of end device, and the like. Thus, although in FIG. 1 the cache memory 113 is indirectly connected to the external connection 121, it will be appreciated that the central processing unit 110 may include any one or more, or all portions of the functionality of the North/South bridge chipset 120, hence resulting in the external connection being directly connected to the central processing unit (110) (e.g. see FIG. 4).

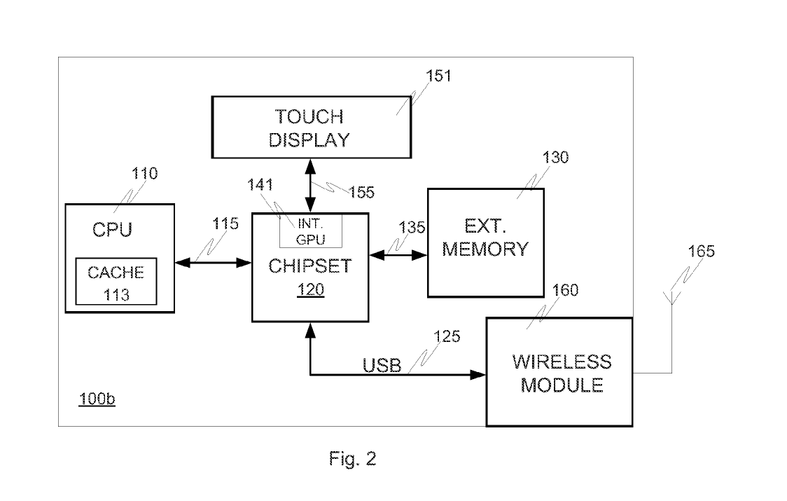

FIG. 2 schematically shows a second example of an embodiment of a data processing system to which the present invention may apply. In this example, the data processing system is simplified compared to FIG. 1, since it represents a commoditised mobile data processing system.

FIG. 2 shows a typical mobile data processing system 100b, such as tablet, e-book reader or the like, which has a more integrated approach than the data processing system of FIG. 1, in order to reduce costs, size, power consumption and the like. The mobile data processing system 100b of FIG. 2 comprises a CPU 110 including cache memory 113, a chipset 120, main external system memory 130, and their respective interfaces (CPU interface 115 and external memory interface 135), but the chipset 120 also has an integrated GPU 141, connected in this example to a touch display via bi-directional interface 155. The bi-directional interface 155 is to allow the display information to be sent to the touch display 151, whilst also allowing the touch control input from the touch display 151 to be sent back to the CPU 110 via chipset 120, and interfaces 155 and 115. The integrated GPU 141 is integrated into the chipset to reduce overall cost, power usage and the like.

FIG. 2 also only shows an external USB connection 125 for connecting a wireless module 160 having antenna 165 to the chipset 120, CPU 110, main external system memory 130, etc. The wireless module 160 enables the mobile data processing system 100b to connect to a wireless network for providing program code data and/or content data to the mobile device. The mobile data processing system 100b may also include any other standardised internal or external connection interfaces (such as the IEEE1394b, Ethernet, Audio Input/Output interfaces of FIG. 1). Mobile devices in particular, may also include some non-standard external connection interfaces (such as a proprietary docking station interface). This is all to say that the present invention is not limited by which types of internal/external connection interfaces are provided by or to the mobile data processing system 100b.

Typically, in such consumer/commoditised data processing systems, a single device 100b for use worldwide may be developed, with only certain portions being varied according to the needs/requirements of the intended sales locality (i.e. local, federal, state or other restrictions or requirements). For example, in the mobile data processing system 100b of FIG. 2, the wireless module may be interchanged according to local/national requirements. For example, an IEEE 802.11n and Universal Mobile Telecommunications System (UMTS) wireless module 160 may be used in Europe, whereas an IEEE 802.11n and Code Division Multiple Access (CDMA) wireless module may be used in the United States of America. In either situation, the respective wireless module 160 is connected through the same external connection interface, in this case the standardised USB connection 125.

Regardless of the form of the data processing system (100a or 100b), the way in which the cache memory is used by the overall system is generally similar. In operation, data processing system (100a/b) functions to implement a variety of data processing functions by executing a plurality of data processing instructions (i.e. the program code and content data). Cache memory 113 is a temporary data store for frequently-used information that is needed by the central processing unit 110. In one embodiment, cache memory 113 may be a set-associative cache memory. However, the present invention is not limited to any particular type of cache memory. In one embodiment, the cache memory 113 may be an instruction cache which stores instruction information (i.e. program code), or a data cache which stores data information (i.e. content data, e.g. operand information). In another embodiment, cache memory 113 may be a unified cache capable of storing multiple types of information, such as both instruction information and data information.

The cache memory 113 is a very fast (i.e. low latency) temporary storage area for data currently being used by the CPU 110. It is loaded with data from the main external system memory 130, which in turn loads data from a main, non-volatile, storage (not shown), or any other external device. The cache memory 113 generally contains a copy (i.e. not the original instance) of the respective data, together with information on: where the original data instance can be found in main external system memory 130 or main non-volatile storage; whether the data has been amended by the CPU 110 during use; and whether the respective amended data should be returned to the main external system memory 130 after use, to ensure data integrity (the so called “dirty bit” as discussed in more detail below).

Note that data processing system (100a/b) may include any number of cache memories, which may include any type of cache, such as data caches, instruction caches, level 1 caches, level 2 caches, level 3 caches, and the like.

The following description will discuss an example in the context of using the afore-mentioned mobile data processing system 100b with a wireless module 160 connected through external USB connection 125 to the central processing unit 110, where the wireless module provides content data for use and display on the mobile data processing system 100b. A typical use/application of such a device is to browse the web whilst on the move. Whilst the web browsing task only requires very low CPU Millions of Instructions Per Second (MIPS), i.e. it only has a low CPU usage, considerable amounts of data must still be transferred from the wireless module 160 connected to the wireless network (e.g. wireless local access network—WLAN, or UMTS cellular network, both not shown) to the CPU 110 for processing into display content on the display 151.

One of the more important figures of merit in such a use case, is the web page processing time. This is because users are sensitive to delays in processing of web pages, and this is an increasingly important issue as web pages increase the size of content used, for example including streaming video and the like. In order to improve user experience, the CPU's network access latency may be reduced.

Regardless of the type of data (program code, or content) involved, the sooner the data is made available to the CPU 110 for use, the quicker the data can be utilised to produce a result, such as a display of the information to the user. Thus, reducing the time taken for data to become available to the CPU 110 can greatly increase the actual and perceived throughput of a data processing system (100a/b).

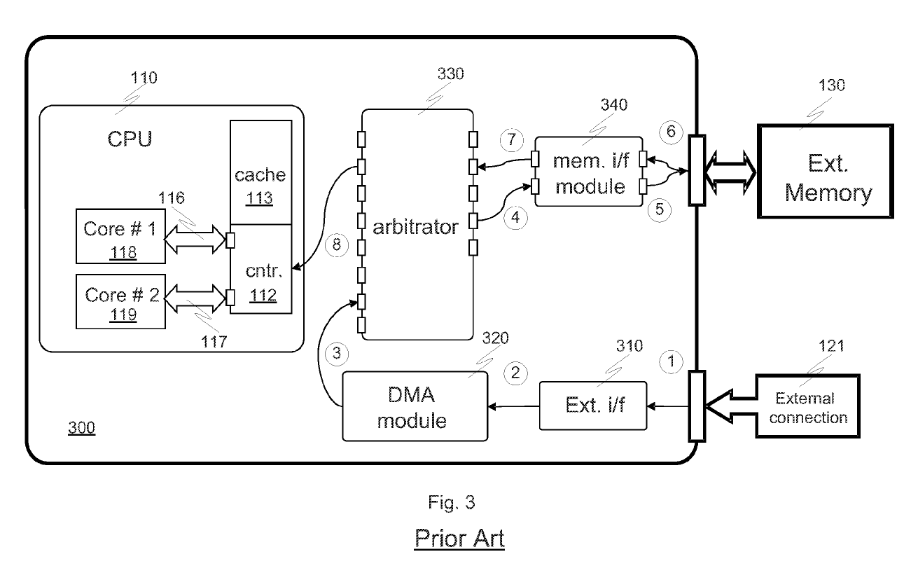

FIG. 3 schematically shows in more detail how data is loaded from an external connection 121 to the central processing unit 110, via main external system memory 130, according to a commonly used data processing system 300 architecture in the prior art. This figure shows the data flow from the external connection 121 (e.g. USB connection 125) through the external interface 310, which provides linkage between the external connection 121 and a Direct Memory Access (DMA) module 320. As its name suggests, the DMA module 320 provides a connected device with direct access to the external memory 130 (without requiring data to pass through the central processing unit processing core(s)), albeit through an arbitrator 330, and memory interface module 340. Thus, data from the external connection 121 is transferred to the main external system memory 130, ready for the CPU 110 to load into its cache memory 113 as required. When data is loaded from main external memory 130 to the cache memory 113, it is done so via memory interface module 340 and the arbitrator 330 connected to the cache controller 112, as and when that data becomes available and is required by the one or more cores (118,119) forming the CPU 110.

The total latency of a prior art system as shown in FIG. 3 is relatively high, since data must be written to the main external system memory 130 first, before it can be copied from the main external system memory 130 to the CPU cache memory 113, ready for use. In more detail, data from an external connection 121 (e.g. USB, AGP, or any other parallel or serial link) is transferred through an external interface module 320, connected to an arbitrator 330, which provides the data to an external memory interface module 340, for writing out to main external system memory 130. Once in the main external system memory 130, the data may be left for later retrieval, or immediately transferred back through the memory interface module 340 and arbitrator 330 to the cache controller 112. The cache controller 112 controls how the data is stored in cache memory 113, including controlling the flushing of the cache memory 113 data back to main external system memory 130 when the respective data in the cache memory 113 is no longer required by the central processing unit 110, or new data needs to be loaded into cache memory 113 and so older data needs to be overwritten due to cache memory size limits. The data in the cache memory 113 typically includes a “dirty bit” to control whether the data in cache memory 113 is written back to main memory 130 (e.g. when the data is modified, and may need to be written back to main memory in modified form, to ensure data coherency), or is simply discarded (when the data is not modified per se, and/or any changes to the data, if present, can be ignored). An example of when data may need to be written back to main external system memory 130, in the example of a web browsing usage model, would be where a user chosen selection field is updated to reflect a choice by a user, and that choice may need to be maintained between web pages on a website, e.g. an e-commerce site. An example of where the data in the cache memory 113 may be discarded after use, since nothing has changed in that data, may be the streaming of video content from a video streaming website, such as YouTube™.

FIG. 4 schematically shows, at the same level of detail of FIG. 3, how data is loaded into the cache memory 113 according to an embodiment of the present invention, avoiding the need to use the arbitrator 330, memory interface module 340 or external memory 130 when data is read into the CPU cache memory 113. It can be seen that the cache memory data loading path is significantly shorter in FIG. 4 when compared the known cache memory data loading method of FIG. 3.

In this example, and in contrast to the data cache memory loading method and apparatus shown and explained with reference to FIG. 3, a reduced latency can be obtained by directly transferring data from the external connection 121 into the CPU cache memory 113, via, for example, a DMA module directly connected to the cache controller 112, with on-the-fly address modification. The on-the-fly address modification/translation may be used to ensure that the information useful for returning the cached data to the correct portion of the main external system memory 130 is available, so that the remainder of the system is not affected by the described modification to the loading of data into cache memory 113.

Whilst FIG. 4 shows a CPU 110 having dual cores, there may be any number of cores, from one upwards. In the example, each core is shown as connected to the cache controller 112 via a dedicated interface 116 or 117. The present invention is in no way limited in the number of cores found within the processor, nor how those cores are interfaced to the cache controller 112.

Whilst the cache controller 112 is shown in FIG. 4 as being formed as part of the CPU 110 itself, it may also be formed separately, or within another portion of the overall system, such as chipset 120 of FIGS. 1 and 2. FIG. 4 also shows the external connection 121 directly connected to the data processing system 300b.

The cache memory 113 may include any type of cache memory present in the system (level 1, 2, or more). However, in typical implementations, the present invention is used together with the last cache memory level, which in contemporary systems is typically the level 2 cache memory, but, for example, may likewise be level 3 cache memory in the case the system has level 1, level 2 and level 3 cache memory.

The on-the-fly address modification may be beneficially included, so that when data is flushed from the cache memory 113 and put back into main external memory 130, it is put back in the correct place, e.g. at the location it would have been sent to had the data been sent to the main external system memory 130 instead of the cache memory 113. This is to say, to ensure data coherency—i.e. the cache memory has the same data to manipulate as the main storage of the data in main external system memory 130, or even non-volatile (i.e. long-term storage) memory such as a hard disk. The on-the-fly modification process may also notify the external memory (through arbitrator 330 and memory interface module 340) of the nominal external memory data locations it will use for the data being sent directly to the cache memory 113, so that when the above described flush operation occurs, there may be correctly sized and located spare data storage locations ready and available in main external system memory 130. Typically, this may be done by modifying the cache memory tags used to track where the cached data came from in the main external system memory 130. Any other means to preserve cache memory 113 and external memory 130 coherency may also be used.

The on-the-fly address modification process may be carried out by any suitable node in the system, such as by a modified DMA module 320, modified cache controller 114, or even an intermediate functional block where appropriate. These different implementation types are shown in FIGS. 4 to 6.

The above described change to the cache memory loading function is on a most critical path when measuring latency of a central processing unit 110. This is because the flush latency (i.e. putting the correct cached data back into main external system memory 130 for use later) is not on the critical path that determines how quickly a user perceives a data processing system to operate. This is to say, the cache flush operation does not affect how quickly data is loaded into the CPU cache memory 113 for use by the CPU 110.

The data that is written directly into the cache memory 113 typically has the main external system memory 130 address in the cache memory tags (or some other equivalent means to locate where in the main external system memory 130 the cached data should go), and a ‘dirty bit’ may also be set, so that if/when the directly written data is no longer required, it may be invalidated by the cache controller 114, and written back to the main external system memory 130 in much the same way as would happen in a conventional cache memory write back procedure.

In other words, the content data may be directly transferred from the external connection 121 to the CPU cache memory 113, whilst having its ‘destination’ address manipulated on the fly to ensure it is put back where it should be within the main external system memory 130 after use. This may improve latency significantly, even in use cases where the current process is interrupted and some data that has been brought to cache memory 113 directly is written back to main external system memory 130, and then re-read out of main external system memory 130 again once the original process requiring that data is resumed.

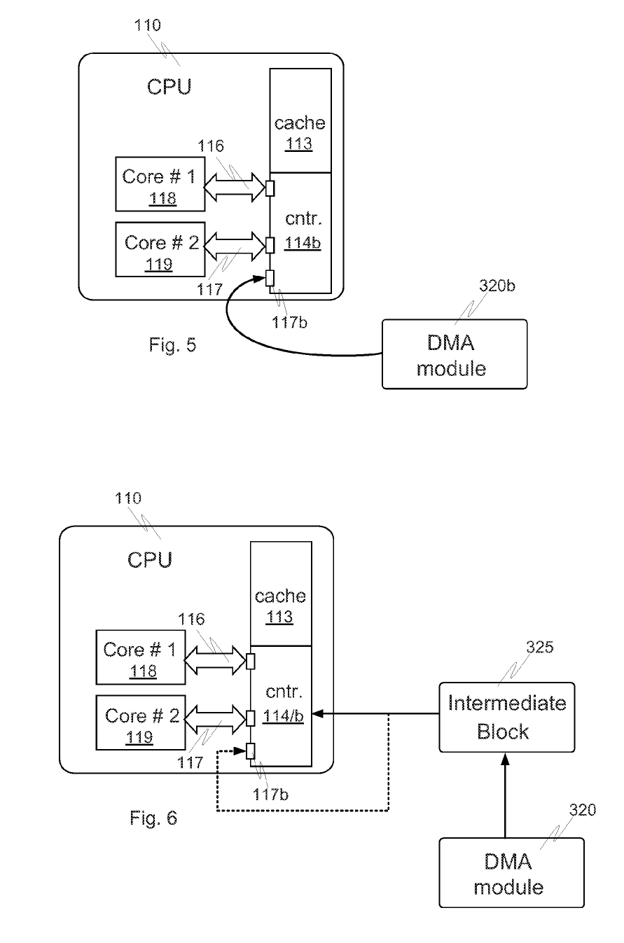

In some embodiments, where the central processing unit 110 is suitably adapted to provide master connections for processing cores, one such master connection may be used for the direct connection of a DMA controller 320 to the cache controller 114. FIG. 5 shows an example of such an embodiment of the present invention. In this case, an adapted smart DMA (SDMA) module 320b is adapted to imitate accesses of a standard CPU core, and is connected to a spare master core connection 117b. This may be used, for example, in modern ARM™ architectures.

In FIG. 6, by contrast, a standard DMA module 320 interfaces with an intermediate block 325 which carries out the address translation operation (converting addresses in the loaded cache data, from referencing the original external connection source address to referencing a reserved address in main external system memory 130) and the setting of the dirty bit to ensure the data is read back out to main external system memory 130 once the respective cached data is no longer required by the CPU 110 at that time. The connection between the intermediate block 325 and cache controller 114 may be a proprietary connection (solid direct line into cache controller 114), or it may be through a core master connection 117b as discussed above (shown as dotted line).

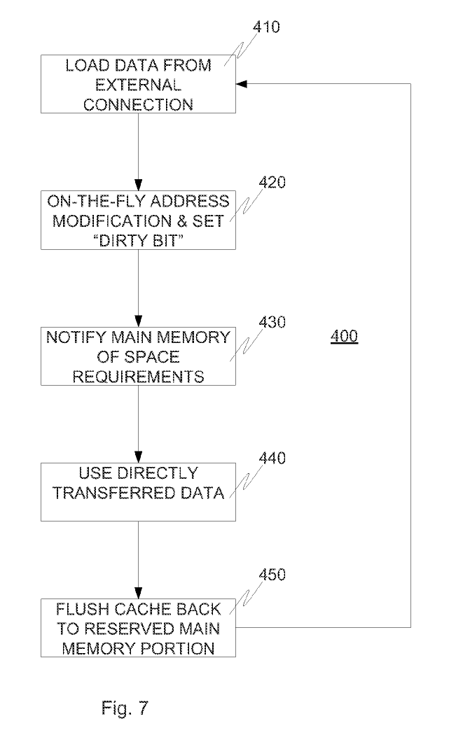

FIG. 7 shows an embodiment of the method according to the present invention 400. The method comprises loading data directly from the external connection 121 at step 410. At step 420, the directly loaded data has its ‘source’ destination address modified on-the-fly, so that it points to a portion of the main external system memory 130 (for example, pointing to where the data would have been sent to in main external system memory 130 in the prior art), and a dirty bit is set to ensure the directly loaded data is returned to main external system memory 130 after use, ready for subsequent re-use in the normal way. The main external system memory 130 may be notified of the addresses used in the on-the-fly address modification at step 430, so that the main external system memory 130 may reserve the respective portion for when the respective data is flushed back to the main external system memory 130. At step 440, the directly loaded data may be used by the CPU 110 in the usual way. At step 450, the used data (or, indeed, data that has not been used in the end, due to an overriding request upon the CPU 110 from the user or other portions of the overall system, e.g. due to an interrupt or the like) may be flushed back from the cache memory 113 to the main memory 130. The method then returns the beginning, i.e. loading fresh data directly from the external connection 121 to the CPU cache memory 113.

The exact order in which the on-the-fly address manipulation 420, notification 430 and even use of the data 440 may vary according to specific requirements of the overall system, and may be carried out by a variety of different entities within the system, for example in a modified cache controller 114/b, modified DMA controller 320b or intermediate block 325.

Accordingly, examples show a method of reducing latency in a data processing system, in particular a method of reducing cache memory latency in a processor (e.g. CPU 110, having one or more processing cores) operably coupled to a processor cache memory 113 and main external system memory 130, by directly loading data from an external connection 121 (e.g. USB connection 125) into cache memory (e.g. on die level 2 cache memory 113) without the data being loaded into main external system memory 130 first. In the example described, the “source” address stored in the cache memory 113 is changed so that it points to a free portion of the main external system memory 130, such that once the cached data is not longer required, the data can be flushed back into the main external memory 130 in the normal way. The main external system memory 130 may then reserve the required space. To this end, the main memory controller preferably receives an indication of which portions of the main memory 130 are being reserved by the data being directly loaded in to the cache memory, so that no other process can use that space in the meantime. However, in some embodiments, the allocation of the space required in the main external system memory 130 may be carried out during the flush operation instead.

The above described method and apparatus may be accomplished, for example, by adjusting the structure/operation of the data processing system, and in particular, the cache controller (in the exemplary figures, item 114 refers to a modified cache controller, whilst use of suffix “b” refers to different ways in which other portions of the system connect to said modified cache controller 114/b), DMA controller or any other portion of the data processing system. Also, a new intermediate functional block may be used to provide the above described direct cache memory loading method instead.

Some of the above embodiments, as applicable, may be implemented in a variety of different information/data processing systems. For example, although the figures and the discussion thereof describe exemplary information processing architectures, these exemplary architectures are presented merely to provide a useful reference in discussing various aspects of the invention. Of course, the description of the architectures has been simplified for purposes of discussion, and it is just one of many different types of appropriate architectures that may be used in accordance with the invention. Those skilled in the art will recognize that the boundaries between logic blocks are merely illustrative and that alternative embodiments may merge logic blocks or circuit elements or impose an alternate decomposition of functionality upon various logic blocks or circuit elements.

Thus, it is to be understood that the architectures depicted herein are merely exemplary, and that in fact many other architectures can be implemented which achieve the same functionality. In an abstract, but still definite sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Also for example, in some embodiments, the illustrated elements of data processing systems 100a/b are circuitry located on a single integrated die or circuit or within a same device. Alternatively, data processing systems 100a/b may include any number of separate integrated circuits or separate devices interconnected with each other. For example, cache memory 113 may be located on a same integrated circuit as CPU 110 or on a separate integrated circuit or located within another peripheral or slave discretely separate from other elements of data processing system 100a/b. Also for example, data processing system 100a/b or portions thereof may be soft or code representations of physical circuitry or of logical representations convertible into physical circuitry. As such, data processing system 100a/b may be embodied in a hardware description language of any appropriate type.

Computer readable media may be permanently, removably or remotely coupled to an information processing system such as data processing system 100a/b. The computer readable media may include, for example and without limitation, any number of the following: magnetic storage media including disk and tape storage media; optical storage media such as compact disk media (e.g., CD-ROM, CD-R, etc.) and digital video disk storage media; nonvolatile memory storage media including semiconductor-based memory units such as FLASH memory, EEPROM, EPROM, ROM; ferromagnetic digital memories; MRAM; volatile storage media including registers, buffers or cache memories, main memory, RAM, etc.; and data transmission media including computer networks, point-to-point telecommunication equipment, and carrier wave transmission media, just to name a few. Data storage elements (e.g. cache memory 113, external system memory 130 and storage media) may be formed from any of the above computer readable media technologies that provide sufficient data throughput and volatility characteristics for the particular use envisioned for that data element.

As discussed, in one embodiment, data processing system 10 is a computer system such as a personal computer system 100a. Other embodiments may include different types of computer systems, such as mobile data processing system 100b. Data processing systems are information handling systems which can be designed to give independent computing power to one or more users. Data processing systems may be found in many forms including but not limited to mainframes, minicomputers, servers, workstations, personal computers, notepads, personal digital assistants, electronic games, automotive and other embedded systems, cell phones and various other wireless devices. A typical computer system includes at least one processing unit, associated memory and a number of input/output (I/O) devices.

A data processing system processes information according to a program and produces resultant output information via I/O devices. A program is a list of instructions such as a particular application program and/or an operating system. A computer program is typically stored internally on computer readable storage medium or transmitted to the computer system via a computer readable transmission medium, such as wireless module 160. A computer process typically includes an executing (running) program or portion of a program, current program values and state information, and the resources used by the operating system to manage the execution of the process. A parent process may spawn other, child processes to help perform the overall functionality of the parent process. Because the parent process specifically spawns the child processes to perform a portion of the overall functionality of the parent process, the functions performed by child processes (and grandchild processes, etc.) may sometimes be described as being performed by the parent process.

Although the invention is described herein with reference to specific embodiments, various modifications and changes can be made without departing from the scope of the present invention as set forth in the claims below. For example, the number of bits used in the address fields may be modified based upon system requirements. Also for example, whilst the specific embodiment is disclosed as improving web browsing via an external USB network device, the present invention may equally apply to any other external or internal interface connections found within or on a processor, or data processing system. This is to say, the term “external”, especially within the claims, is meant with reference to the CPU and/or cache memory, and thus may include “internal” connections between, for example, a storage device such as CD-ROM drive and the CPU, but does not include the connection to the main external system memory.

Accordingly, the specification and figures are to be regarded in an illustrative rather than a restrictive sense, and all such modifications are intended to be included within the scope of the present invention. Any benefits, advantages, or solutions to problems that are described herein with regard to specific embodiments are not intended to be construed as a critical, required, or essential feature or element of any or all the claims.

The term “coupled,” as used herein, is not intended to be limited to a direct coupling or a mechanical coupling.

Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles.

Unless stated otherwise, terms such as “first” and “second” are used to arbitrarily distinguish between the elements such terms describe. Thus, these terms are not necessarily intended to indicate temporal or other prioritization of such elements.

Also, the invention is not limited to physical devices or units implemented in non-programmable hardware but can also be applied in programmable devices or units able to perform the desired device functions by operating in accordance with suitable program code, such as Field Programmable Gate Arrays (FPGAs).

In the claims, any reference signs placed between parentheses shall not be construed as limiting the claim. The word ‘comprising’ does not exclude the presence of other elements or steps then those listed in a claim.

1. A data processing system comprising:
a central processing unit;
a processor cache memory operably coupled to the central processing unit; and
an external connection operably coupled to the central processing unit and processor cache memory, wherein a portion of the data processing system is arranged to:
load data directly from the external connection into the processor cache memory, and
modify a source address of said directly loaded data.

2. The data processing system of claim 1 further comprising:
a main external system memory, wherein and the portion of the data processing system is further arranged to modify the source address to point towards a portion of main external system memory.

3. The data processing system of claim 1, wherein the portion of the data processing system is further arranged to set a dirty bit for the directly loaded data.

4. The data processing system of claim 2, wherein the portion of the data processing system is further arranged to notify the main external system memory of a portion of data storage in the main external system memory to be reserved for storing the directly loaded data after use.

5. The data processing system of claim 1, wherein the processor cache memory is level 2 cache memory.

6. The data processing system of claim 1, wherein the portion of the data processing system comprises a cache controller.

7. The data processing system of claim 1, further comprising:
a cache controller, wherein
the portion of the data processing system comprises a modified DMA module or an intermediate block.

8. The data processing system of claim 7, wherein the modified DMA controller or intermediate block is operably coupled to the cache controller through a proprietary connection or a dedicated master core connection.

9. The data processing system of claim 1, wherein the external connection comprises a USB connection.

10. A method of improving latency in a data processing system, the method comprising:
loading data directly from an external connection into a processor cache memory coupled to the external connection; and
modifying, by a central processing unit coupled to the external connection and processor cache memory, a source address for said data to become indicative of a location other than from the external connection.

11. The method of claim 10 further comprising:
modifying the source address for said data to become indicative of a location in a main external system memory coupled to the central processing unit.

12. The method of claim 10, further comprising setting a dirty bit for all data directly loaded into the processor cache memory.

13. The method of claim 11, further comprising notifying the main external system memory of a portion of data storage in the main external system memory to be reserved for storing the directly loaded data after use.

14. The method of claim 10, wherein the steps of modifying and notifying occur simultaneously with the loading of the data into the processor cache memory.

15. The data processing system of claim 3, wherein the portion of the data processing system is further arranged to notify the main external system memory of a portion of data storage in the main external system memory to be reserved for storing the directly loaded data after use.

16. The data processing system claim 2, further comprising:
a cache controller, wherein
the portion of the data processing system comprises a modified DMA module or an intermediate block.

17. The method of claim 11, further comprising setting a dirty bit for all data directly loaded into the processor cache memory.

18. The method of claim 12, further comprising notifying the main external system memory of a portion of data storage in the main external system memory to be reserved for storing the directly loaded data after use.
